(19) United States
(12) Patent Application Publication
(10) Pub. No.: US 2009/0061128 A1
(43) Pub. Date: Mar. 5, 2009

(54) SILICONE BAKEWARE

(76) Inventor: I-Wen Liu, Taipei City (TW)

Correspondence Address: I-Wen LIU, P. O. BOX 90, Tainan City, 70499, TW

(21) Appl. No.: 11/848,244

(22) Filed: Aug. 31, 2007

(51) Int. Cl. B32B 1/04

(52) U.S. Cl. 428/34.4

(57) ABSTRACT

A silicone bakeware provided with an upper rim has at least one support wire ring wrapped up in outer surfaces of the silicone bakeware, and plural shuttles fitted and spaced apart on the at least one support wire ring. The shuttles made of a compatible material to silicone rubber are provided with plural tooth-shaped grooves in an outer surface. The at least one support wire ring is in advance placed in groove of a female mold and kept therein at a distance from the inner wall surface of the groove and located in the center of the groove without biasing. In the process of forming the silicone bakeware in a mold by injection molding, the at least one support wire ring is wrapped up in a balanced condition with the silicone rubber material and held by the shuttles to augment its stress, preventing it from disfiguring.

### BACKGROUND OF THE INVENTION

1. Field of the Invention

This invention relates to a silicone bakeware, particularly to one having at least one support wire ring in outer surfaces of the silicone bakeware, and plural shuttles fitted and spaced apart properly on the at least one support wire ring and each provided with plural tooth grooves in an outer surface. Therefore, when the silicone bakeware is formed by injecting molding process, the shuttles can keep the at least one support wire ring just in the center of the groove of a mold used for forming the silicone bakeware by injecting process. Moreover, the shuttles can reinforce the at least one support wire ring for preventing it from disfiguring.

2. Description of the Prior Art

A conventional silicone bakeware 1 shown in FIGS. 1 and 2, includes a steel wire 11 in an upper rim 10 to reinforcing the supporting force of the upper rim 10.

However, there are some disadvantages in the process of forming the conventional silicone bakeware 1 by a mold, as described below.

1. The steel wire 11 is to be in advance placed in a groove (A10) of the mold (A), and the groove (A10) has to be provided with plural support posts (A100) for keep the steel wire 11 in position. When the finished silicone bakeware 1 is taken out of the mold, the support posts (A100) may form holes 12 in the upper rim 10 of the silicone bakeware 1, with the steel wire 11 exposing out at the holes 12, so consequently the silicone bakeware 1 is impossible to be used in a micro wave oven.

2. In processing, the steel wire 11 is dangling in the groove (A10) of the mold (A), not kept in position by any means, resulting in high failure in the finished products. Or the steel wire 11 is welded in the upper rim or inserted therein in the incorrect position, very difficult to position the steel wire 11 in the correct location, complicating its process.

3. The steel wire 11 is placed in advance in the groove (A10) of the mold (A) before injecting, so the steel wire 11 is easily shifted away from its correct position by instant impact of injecting silicone rubber material in the mold (A).

4. The steel wire 11 is placed in advance in the groove (A10) of the mold (A) is apt to disfigure, or have its welded point disrupted by instant impact of the silicone rubber injected in the mold (A), resulting in incomplete wrapping of the steel wire 11 to become an unqualified product.

### SUMMARY OF THE INVENTION

The objective of the invention is to offer a silicone bakeware having at least one support wire ring wrapped up in outer surfaces of the silicone bakeware and a plurality of shuttles fitted and spaced apart properly on the at least one support wire ring. Each of the shuttles is provided with plural tooth-shaped grooves in an outer surface. The at least one support wire ring fitted with the shuttles is in advance placed in a groove of a mold and can be kept immovable by the shuttles in the center of the groove of the mold without biasing during injecting silicone rubber material in the mold for forming the silicone bakeware. Thus the support wire ring fitted with the shuttles is completely wrapped up by the silicone rubber material in a balanced condition, with the shuttles increasing the stress of the at least one support wire ring without possibility of disfiguring, stepping up the sustaining force of the at least one support wire ring for the silicone bakeware.

The main feature of the invention is to provide a silicone bakeware having at least one support wire ring wrapped up in outer surfaces of the silicone bakeware and a plurality of shuttles fitted and spaced apart properly on the at least one support wire ring, each of the shuttles provided with a passageway.

### BRIEF DESCRIPTION OF DRAWINGS

This invention will be better understood by referring to the accompanying drawings, wherein:

FIG. 1 is a perspective view of a mold for a conventional silicone bakeware;

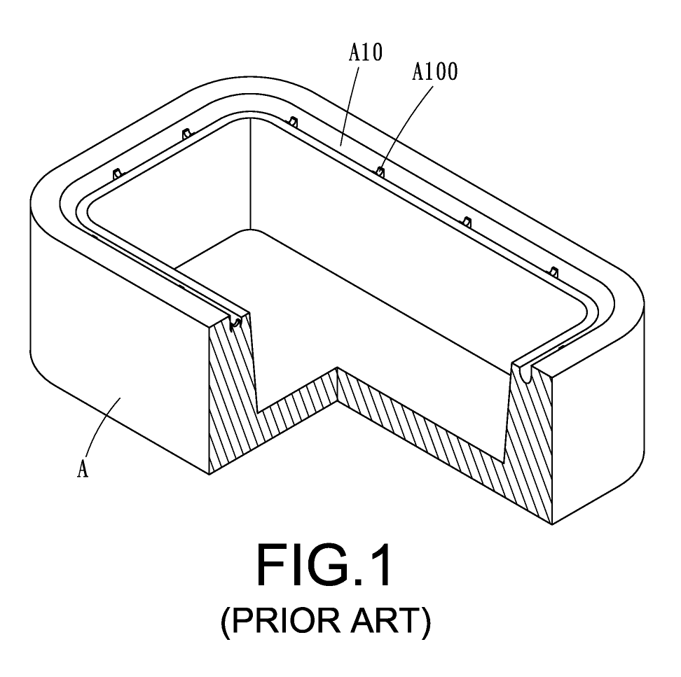

FIG. 2 is a perspective and partial cross-sectional view of the conventional silicone bakeware;

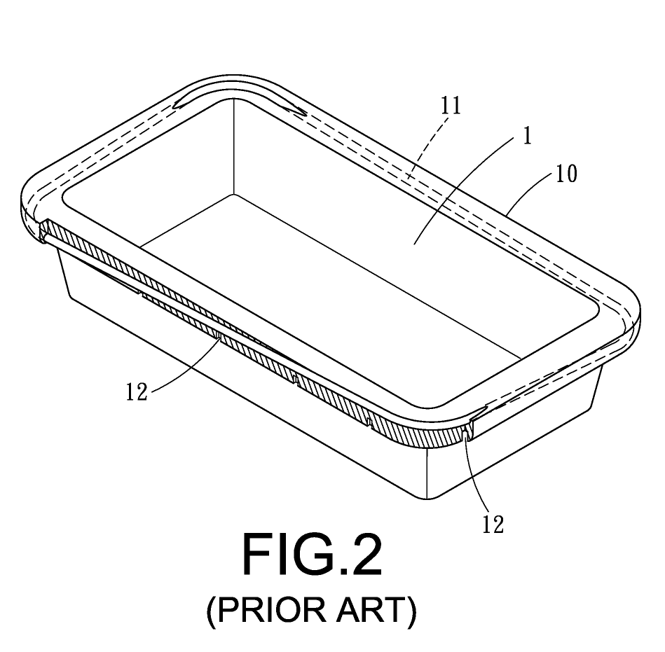

FIG. 3 is a perspective and partial cross-sectional view of a first preferred embodiment of a silicone bakeware in the present invention;

FIG. 4 is an exploded perspective view of a support wire ring and a shuttle in the first preferred embodiment of the silicone bakeware in the present invention;

FIG. 5 is a perspective and partial cross-sectional view of the support wire ring with the shuttles placed in a female mold for forming the silicone bakeware in the present invention;

FIG. 6 is a cross-sectional view of the mold for forming the first preferred embodiment of the silicone bakeware in the present invention, showing a male mold to be fitted in a female mold;

FIG. 7 is a cross-sectional view of the mold for forming the first preferred embodiment of the silicone bakeware in the present invention, showing the male mold having been fitted in the female mold;

FIG. 8 is a perspective view of a support wire ring with shuttles in a second preferred embodiment of a silicone bakeware in the present invention;

FIG. 9 is an enlarged perspective view of a shuttle in the second preferred embodiment of the silicone bakeware in the present invention;

FIG. 10 is a perspective view of two support wire rings respectively positioned in outer surfaces of an upper rim and a side wall of the silicone bakeware in the present invention;

FIG. 11 is a cross-sectional view of the two support wire rings of the FIG. 10 positioned in a mold for forming the silicone bakeware in the present invention;

FIG. 12 is a perspective view of two support wire rings respectively positioned in outer surfaces of an upper rim and a bottom of the silicone bakeware in the present invention; and,

FIG. 13 is a cross-sectional view of the two support wire rings of the FIG. 12 positioned in a mold for forming the silicone bakeware in the present invention.

### DETAILED DESCRIPTION OF THE PREFERRED EMBODIMENT

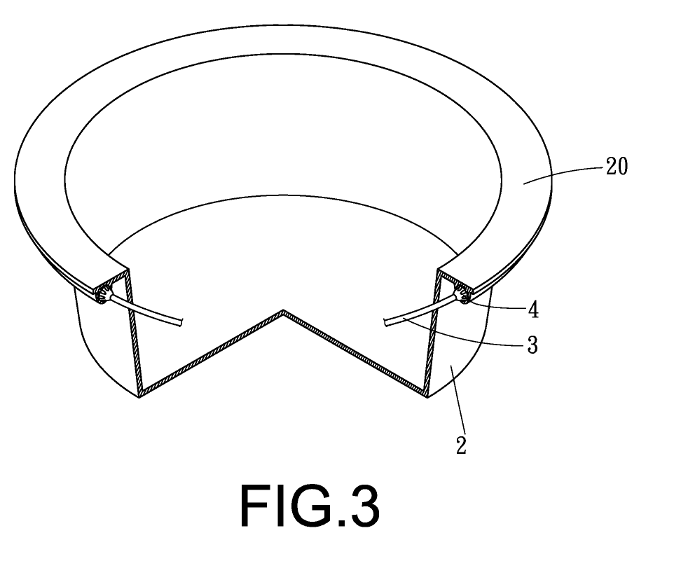

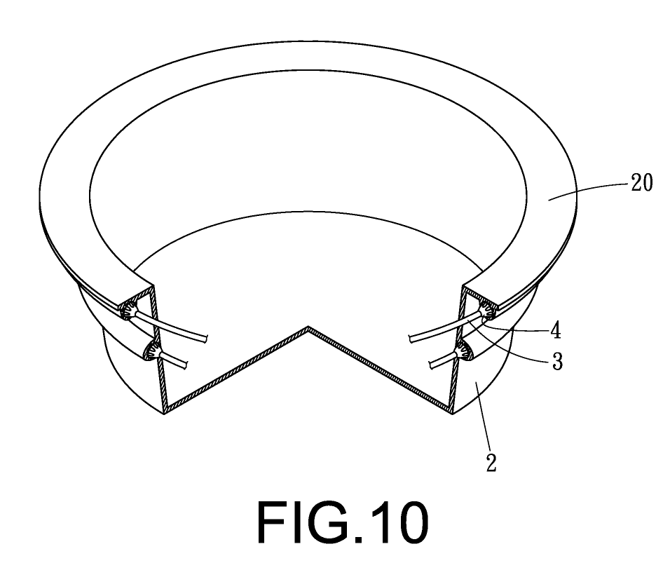

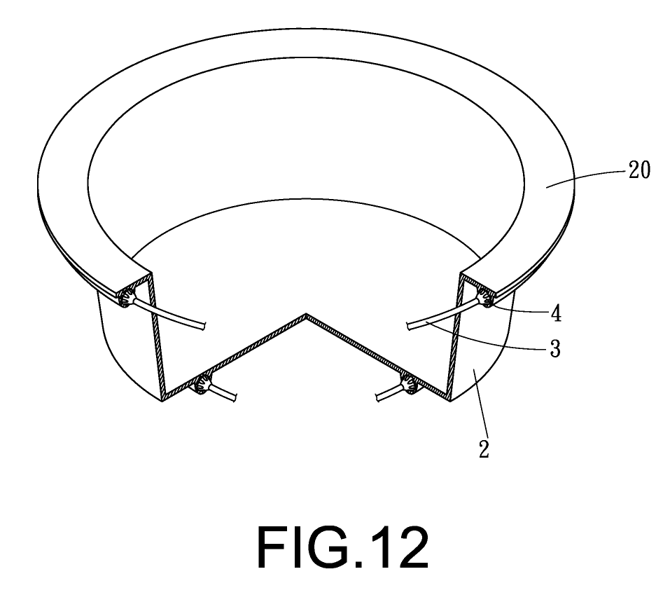

A first preferred embodiment of a silicone bakeware 2 in the present invention, as shown in FIGS. 3, 4 and 8, is provided with an upper rim 20 and has at least one support wire ring 3 wrapped up in outer surfaces of the silicone bakeware 2 such as in the upper rim 20 or in a sidewall or in a bottom (also as shown in FIGS. 10 and 12), and a plurality of shuttles 4 fitted and spaced apart properly on the at least one support wire ring 3. The at least one support wire ring 3 may be a slender metal wire or made of high molecule plastic containing fiber, as the high molecule plastic containing fiber is easily formed by injecting molding process into any geometrical shape. The shuttles 4 are made of material such as silicone rubber, which has high plasticity, endures high temperature and does not easily change its property. Each of the shuttles 4 is provided with a passageway 40 in its center and tooth-shaped grooves 41 axially arranged in an outer surface.

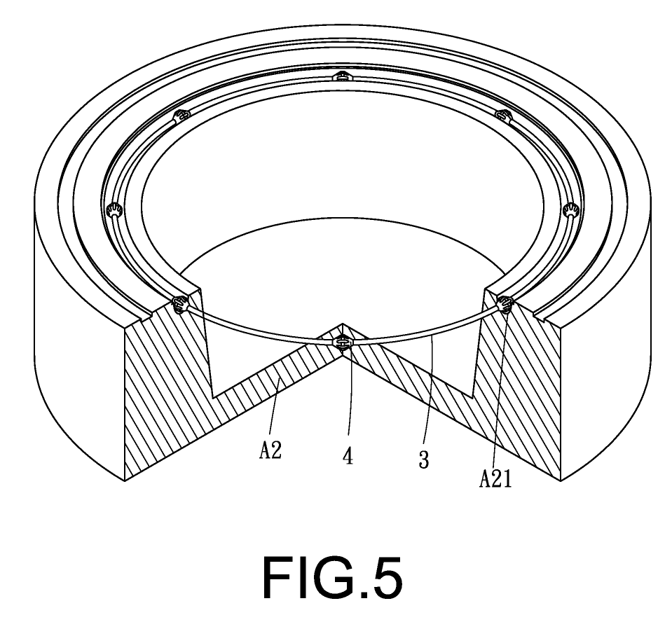

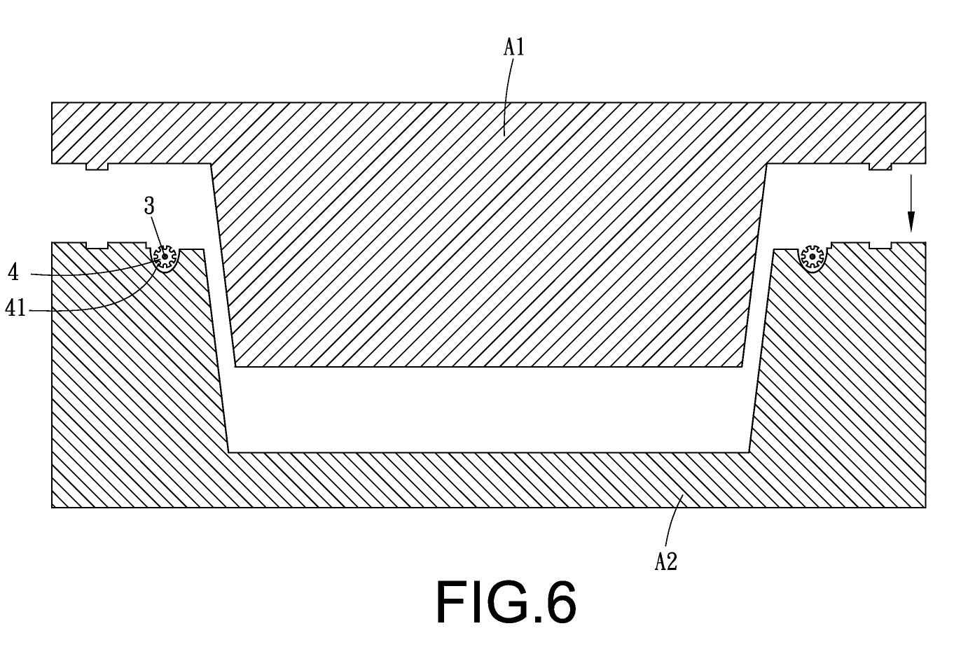

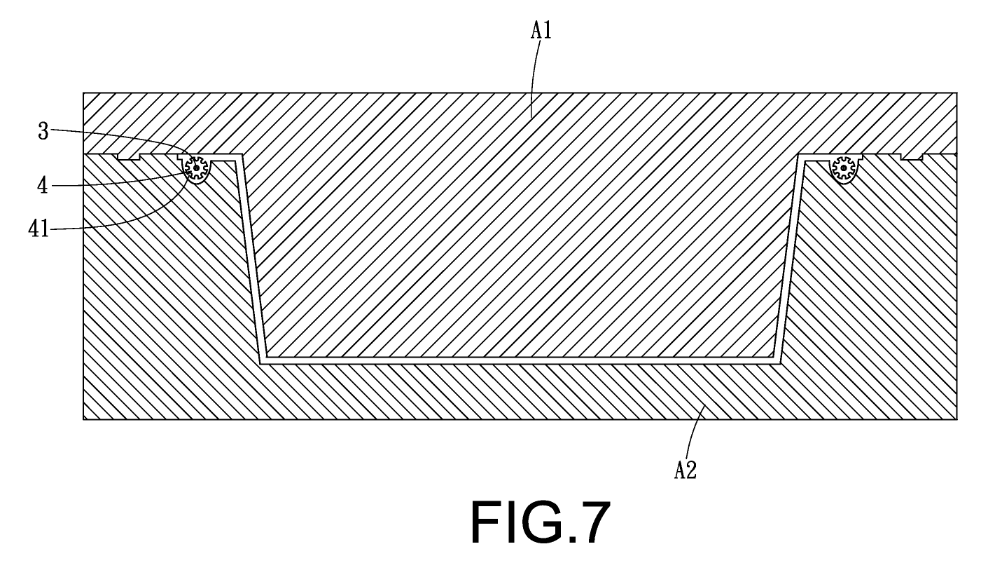

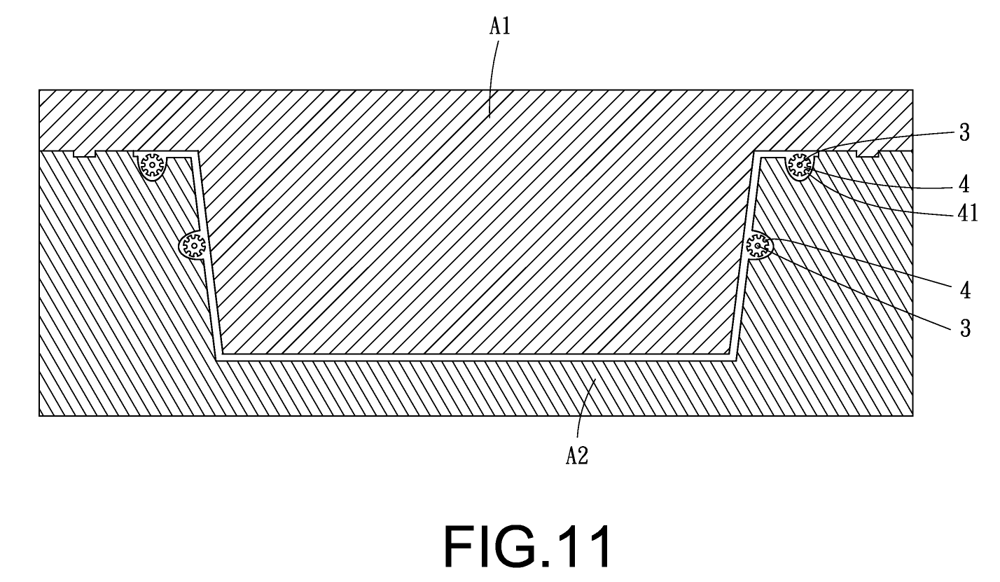

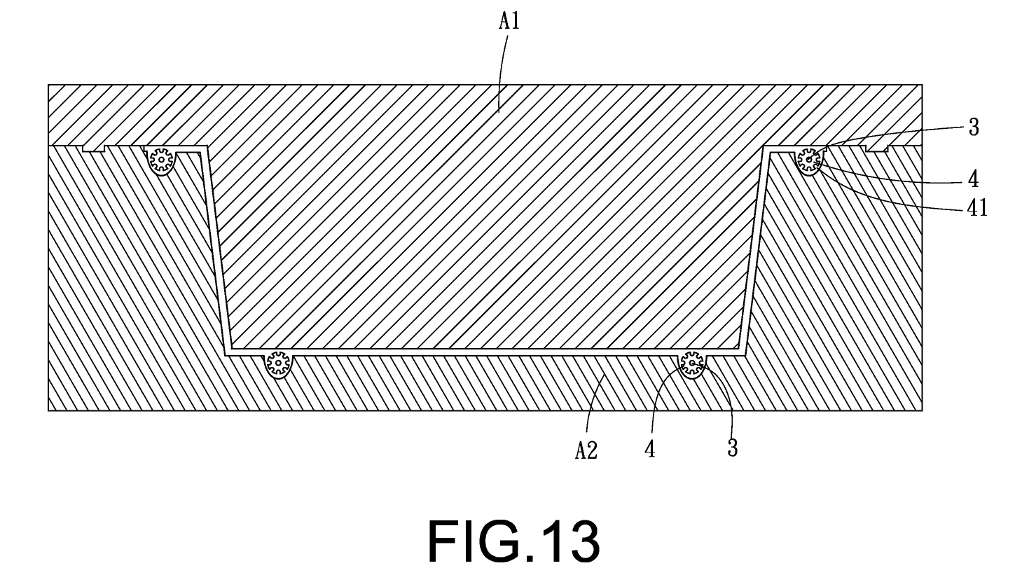

Next, as shown in FIGS. 5, 6 and 7, a mold for forming the silicone bakeware 2 is composed of a male mold (A1) and a female mold (A2). The female mold (A2) is provided with at least one groove (A21) in an upper surface or an inner sidewall or a bottom (also as shown in FIGS. 11 and 13), by which the at least one support wire ring 3 is capable of being placed in the at least one groove (A21) of the female mold (A2) in the process of forming the silicone bakeware 2 by a heat compression molding technology or an injection molding technology so as to get a finished silicone bakeware 2 with the at least one support wire ring 3 wrapped up in the outer surfaces of the silicone bakeware 2.

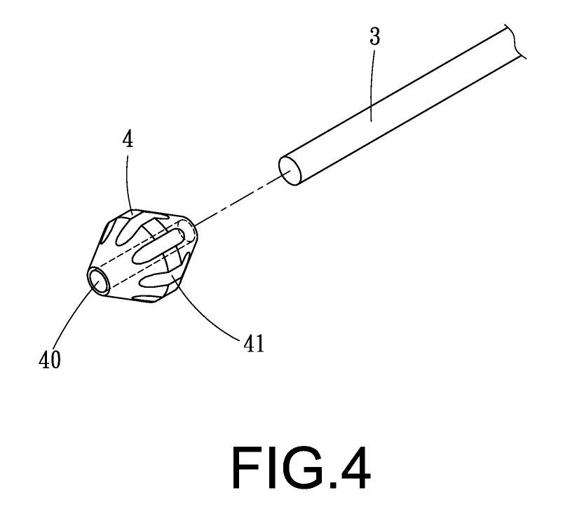

In injecting process, as shown in FIGS. 4-7, 11 and 13, firstly, fit proper quantity of the shuttles 4 on the at least one support wire ring 3, with the two ends of each the at least one support wire ring 3 jointed together, forming a frame-shape support strip. Secondly, place the at least one support wire ring 3 in the at least one groove (A21) of the female mold (A2) ready for injection, with the shuttles 4 functioning to keep the at least one support wire ring 3 properly distanced from the inner wall of the at least one groove (A21) and just located in the center of the at least one groove (A21) without biasing. Thirdly, inject silicone rubber material into the mold, by which the injected silicone rubber material immediately fills up the hollow space of the mold to integrate the at least one support wire ring 3 and the shuttles 4 together, with the at least one support wire ring 3 completely wrapped up in the at least one groove (A21) in a balanced condition and held by the shuttles 4 stably with augmented stress, preventing it from disfiguring. In addition, the tooth-shaped grooves 41 of the shuttles 4 filled and engaged with the silicone rubber material are able to strengthen the combination of the at least one support wire ring 3 and the silicone bakeware 2. Moreover, the compatibility of the same silicone rubber material of the shuttles 4 and the silicone bakeware 2 enables the shuttles 4 to be combined with the silicone bakeware 2 integrally, upgrading maintaining the force of the at least one support wire ring 3.

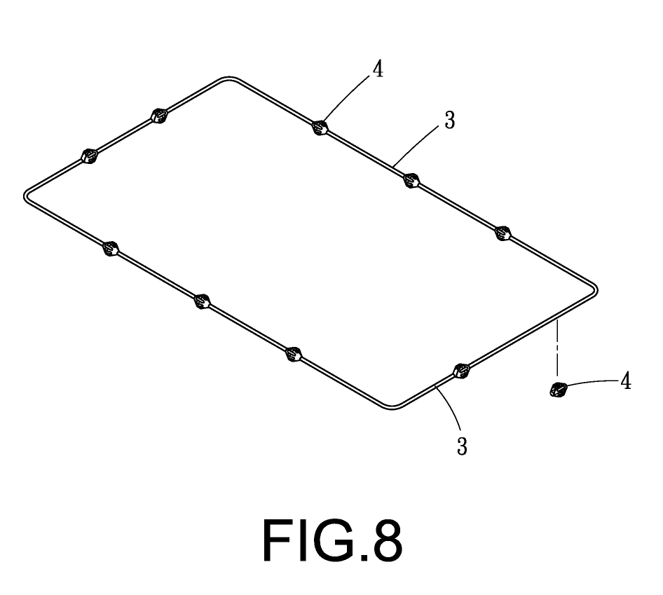

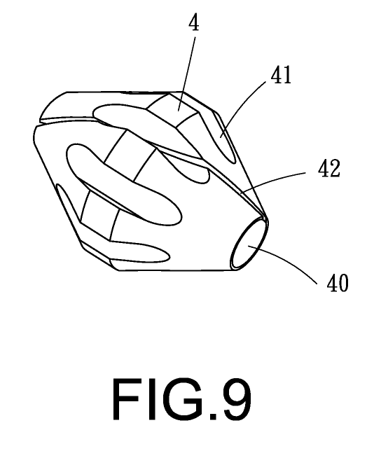

Next, a second preferred embodiment of a silicone bakeware 2 in the invention, as shown in FIGS. 8 and 9, has at least one support wire ring 3 formed as a frame with a predetermined shape and a plurality of shuttles 4 each provided with an inclined cut line 42 extending to the passageway 40, by which the at least one support wire ring 3 can be squeezed into the passageways 40 of the shuttles 4 via the inclined cut lines 42 so that the shuttles 4 can be fitted closely on the at least one support wire ring 3 ready for injection. Therefore, the at least one support wire ring 3 may not be shoved to pop out of the grooves (A21) of the female mold (A2) at the moment of injecting silicone rubber material into the mold to form the silicone bakeware 2, thus achieving the same effect as the first preferred embodiment.

The invention has the following advantages as can be seen from the foresaid description.

1. The at least one support wire ring 3 is kept in position by the shuttles 4 in the grooves (A21) of the female mold (A2) without biasing during forming the silicone bakeware 2, so it is completely wrapped up in a balanced condition after the silicone bakeware 2 is finished

2. The quantity of the shuttles 4 can be reduced or increased according to the size of the at least one support wire ring 3 or the weight that the support wire ring 3 is to be sustained, for augmenting the stress of the support wire ring 3 and preventing it from disfiguring during injection of silicone rubber material in the mold.

3. The shuttles 4 provided with the tooth-shaped grooves 41 and made of silicone rubber material the same as that of the silicone bakeware 2 are possible to be completely integrated with the silicone bakeware 2.

4. The at least one support wire ring 3 can be made of high molecule plastic containing fiber, easy to be shaped by injecting forming process and possible to be made in any geometrical shape. Moreover, the plastic has a similar heat expansion coefficient with that of the silicone rubber, extremely compatible with each other, with no tolerance alteration by heat expansion and cooling shrinkage so that the two materials are easily combined with each other, in addition to a better effect of injecting in a balanced condition.

5. The at least one support wire ring 3 can be placed in outer surfaces of the silicone bakeware 2 such as in the upper rim 20 or in the sidewall or in the bottom of the silicone bakeware 2 according to necessity.

While the preferred embodiments of the invention has been described above, it will be recognized and understood that various modifications may be made therein and the appended claims are intended to cover all such modifications that may fall within the spirit and scope of the invention.

What is claimed is:

1. A silicone bakeware comprising:
said silicone bakeware provided with an upper rim;
at least one support wire ring wrapped up in outer surfaces of said silicone bakeware; and,
a plurality of shuttles fitted and spaced apart properly on said at least one support wire ring, each of said shuttles provided with a passageway.

2. The silicone bakeware as claimed in claim 1, wherein each of said shuttles is provided with an inclined cut line extending to said passageway.

3. The silicone bakeware as claimed in claim 1, wherein said at least one support wire ring is made of high molecule plastic containing fiber, enabling it to be made integrally by injecting molding process, formed into various geometrical shapes.

4. The silicone bakeware as claimed in claim 1, wherein said shuttles are made of silicone rubber, having plural tooth-shaped grooves in an outer surface.
